(19) United States
(12) Patent Application Publication
(10) Pub. No.: US 2026/0036685 A1
(43) Pub. Date: Feb. 5, 2026

(54) FMCW Lidar with a diffractive waveguide

(71) Applicant: APPLE INC., Cupertino, CA (US)

(72) Inventors: Maria I. Campana, Boulder, CO (US); Vyshakh Sanjeev, San Francisco, CA (US); Scott T. Smith, San Jose, CA (US); Tong Chen, Fremont, CA (US); Adam C. Urness, Boulder, CO (US); Shingo Mandai, Mountain View, CA (US); Christopher F. Griffo, Aptos, CA (US); Daniel Ott, Boulder, CO (US); Cristiano L. Niclass, San Jose, CA (US); Christine E. Cordeiro, San Francisco, CA (US); Igor Raginski, San Diego, CA (US); Omer Korech, Pardes Hanna Karkur (IL); Byron R. Cocilovo, Boulder, CO (US); Jong Young Hong, Boulder, CO (US); Kevin A. Keilbach, Boulder, CO (US)

(21) Appl. No.: 19/032,071

(22) Filed: Jan. 19, 2025

Related U.S. Application Data
(60) Provisional application No. 63/677,425, filed on Jul. 31, 2024.

(51) Int. Cl. G01S 7/4911; G01S 7/481; G01S 17/58

(52) U.S. Cl. CPC G01S 7/4911; G01S 7/4816; G01S 17/58

(57) ABSTRACT

Optical sensing apparatus includes a transmitter, which is configured to emit FM coherent optical radiation toward a target. A receiver alongside the transmitter includes an array of optical detectors. An objective optic focuses optical radiation that is reflected from the target onto the receiver. A transparent slab over the transmitter and the receiver has a first face facing the substrate and an opposing second face, which includes a first diffractive structure intercepting the transmit axis and configured to deflect a part of the FM coherent optical radiation to form a local beam propagating diagonally within the transparent slab and reflecting from the second face toward the receive axis. A second diffractive structure on the second face intercepts the receive axis and projects the reflected local beam onto the array of detectors, whereby the local beam mixes at the array with the optical radiation reflected from the target.

### CROSS-REFERENCE TO RELATED APPLICATION

This application claims the benefit of U.S. Provisional Patent Application 63/677, 425, filed Jul. 31, 2024, which is incorporated herein by reference.

### FIELD OF THE INVENTION

The present invention relates generally to systems and methods for optical sensing, and particularly to FMCW LiDAR sensing.

### BACKGROUND

In frequency-modulated continuous-wave (FMCW) light detection and ranging (LiDAR) sensing arrangements, a radio-frequency (RF) chirp is applied to modulate the frequency of a beam of optical radiation (typically a single-mode laser beam) that is directed toward a target. The optical radiation reflected from the target is mixed with a sample of the transmitted light, referred to as a “local oscillator” or “local beam.” The mixed optical radiation is detected by a photodetector, which then outputs an RF signal at a beat frequency that is proportional to the distance to the target. When the target is moving, the resulting Doppler shift of the reflected optical radiation will cause the beat frequency to increase or decrease, depending on the direction of motion.

By comparing the beat frequencies obtained from chirps of positive and negative slopes, it is thus possible to extract both the range and the velocity of the target. In the ideal case, if the beat frequency due to the Doppler shift is d, and the beat frequency due to the chirp and range is r, then the measured beat frequency for the up-chirp will be fᵤ=d+r, and the beat frequency on the down-chirp will be f_{d}=r−d. Thus, the difference of the measured up and down chirp frequencies reveals the Doppler shift, and the sum the range.

Optical metasurfaces are thin layers that comprise a two-dimensional pattern of structures (so-called meta-atoms), having dimensions (pitch and thickness) less than or comparable to the target wavelength of the radiation with which the metasurface is designed to interact. A metasurface is a type of diffractive surface, whose properties are defined by the design of the meta-atoms. For example, some metasurfaces comprise arrays of silicon nano-pillars. Optical elements comprising optical metasurfaces are referred to herein as “metasurface optical elements” (MOEs).

Holograms comprise diffraction gratings, which are generated either by exposing a light-sensitive material to two interfering optical waves or by writing an equivalent computer-generated pattern in a material by, for example, an electron beam (known as a computer-generated hologram, or CGH). A hologram emits one of the generating optical waves when illuminated by the other wave. Holograms may be constructed either as surface holograms or as volume grating holograms (VGHs). In volume phase holograms (VPHs), a subset of VGHs, the refractive index within the volume of the hologram is modulated in the fabrication process; a VPH provides a good control of the diffracted orders, such as concentrating all or most of the diffracted optical power into a single order.

Diffractive optical elements (DOEs) comprise diffractive structures, which split and/or deflect optical radiation. Diffractive structures in this context include gratings, which may be formed on the surface or in the bulk of an optical substrate, including VPHs, as well as metamaterials and particularly metasurfaces. Thus, the terms “diffractive optical element” and “DOE,” as used in the context of the present description and in the claims, include, without limitation, optical elements based on holograms and on metasurfaces.

The terms “light” and “optical radiation,” as used in the context of the present description and in the claims, refer to electromagnetic radiation in any of the visible, ultraviolet, and infrared spectral bands.

### SUMMARY

Embodiments of the present invention that are described hereinbelow provide improved apparatus and methods for optical sensing.

There is therefore provided, in accordance with an embodiment of the invention, optical sensing apparatus, including a substrate, a transmitter, which is disposed on the substrate and is configured to emit frequency-modulated (FM) coherent optical radiation along a transmit axis toward a target, and a receiver, which is disposed on the substrate alongside the transmitter and includes an array of detectors of optical radiation. An objective optic is configured to focus the optical radiation that is reflected from the target onto the receiver along a receive axis. A transparent slab is disposed over the transmitter and the receiver and has a first face facing the substrate and a second face opposite the first face. The second face includes a first diffractive structure, which is disposed in a first location intercepting the transmit axis and is configured to deflect a part of the FM coherent optical radiation to form a local beam propagating diagonally within the transparent slab and reflecting from the second face toward the receive axis, and a second diffractive structure, which is disposed in a second location intercepting the receive axis and is configured to deflect and project the reflected local beam onto the array of detectors, whereby the local beam mixes at the array with the optical radiation reflected from the target.

In some embodiments, the apparatus includes processing circuitry, which is configured to receive electrical signals from the array of detectors in response to the mixed optical radiation and to extract a beat frequency from the electrical signals.

In some embodiments, the transmitter includes an array of emitters of optical radiation. Additionally or alternatively the transmitter includes one or more vertical-cavity surface-emitting lasers (VCSELs). Further additionally or alternatively, the detectors include single-photon avalanche photodiodes (SPADs).

In some embodiments, at least one of the first and second diffractive structures includes a diffraction grating, as such a surface relief grating (SRG). Additionally or alternatively, at least one of the first and second diffractive structures includes a metasurface.

In another embodiment, at least one of the first and second diffractive structures includes a hologram, such as a volume phase hologram (VPH) and possibly a diffusing VPH.

In a disclosed embodiment, the first diffractive structure is configured to focus optical radiation impinging on the diffractive structure. Additionally or alternatively, the apparatus includes a refractive optical lens adjacent to the first diffractive structure and/or an optical diffuser adjacent to the first diffractive structure.

In some embodiments, the second diffractive structure is configured to focus optical radiation impinging on the second diffractive structure. Additionally or alternatively, the apparatus includes an optical diffuser adjacent to the second diffractive structure.

In a disclosed embodiment, the second diffractive structure includes first diffractive elements configured to deflect and focus the local beam onto the detector array interleaved with second diffractive elements configured to transmit and focus the optical radiation reflected from the target onto the detector array.

In some embodiments, the transparent slab includes an optical diffuser configured to diffuse the local beam. The optical diffuser mat be embedded in the transparent slab or disposed on one of the first and second faces of the transparent slab.

In some embodiments, the apparatus includes a beam conditioner disposed on the second face of the transparent slab and configured to receive the optical radiation transmitted by the first diffractive structure and to project the optical radiation onto the target. In the disclosed embodiments, the beam conditioner is selected from a group of optical elements consisting of a diffractive structure, a diffuser, and a refractive optical element. The optical radiation projected onto the target may illuminate the target with flood illumination and/or with a pattern of spots.

In a disclosed embodiment, the transparent slab includes a compound slab, which includes a first slab including the first and second diffractive structures and a second slab, parallel to the first slab, including the beam conditioner. In one embodiment, the objective optic includes a diffractive structure disposed on the second slab.

Additionally or alternatively, the objective optic includes a diffractive structure disposed on one of the faces of the slab.

In a disclosed embodiment, the second diffractive structure has diffractive properties that vary along a direction that is perpendicular to a line connecting the first diffractive structure to the second diffractive structure.

In some embodiments, the objective optic is located between the transparent slab and the substrate. In other embodiments, the transparent slab is located between the objective optic and the substrate.

There is also provided, in accordance with an embodiment of the invention, a method for optical sensing, which includes emitting frequency-modulated (FM) coherent optical radiation along a transmit axis toward a target and focusing optical radiation that is reflected from the target along a receive axis onto an array of optical detectors. A transparent slab is positioned to intercept the transmit and receive axes. The slab has a first face and a second face opposite the first face and facing toward the target. The second face includes a first diffractive structure, which is disposed in a first location intercepting the transmit axis and is configured to deflect a part of the FM coherent optical radiation to form a local beam propagating diagonally within the transparent slab and reflecting from the second face toward the receive axis. A second diffractive structure is disposed in a second location intercepting the receive axis and is configured to deflect and project the reflected local beam onto the array of detectors, whereby the local beam mixes at the array with the optical radiation reflected from the target.

The present invention will be more fully understood from the following detailed description of the embodiments thereof, taken together with the drawings in which:

### BRIEF DESCRIPTION OF THE DRAWINGS

FIG. 1 is a schematic sectional view of an optical sensing apparatus, in accordance with an embodiment of the invention;

FIGS. 2A, 2B, 2C, and 2D are schematic sectional views showing alternative schemes of propagation of a local beam in the apparatus of FIG. 1, in accordance with embodiments of the invention;

FIGS. 2E, 2F and 2G show three schematic views of a further alternative scheme of propagation of the local beam in the apparatus of FIG. 1, in accordance with an embodiment of the invention;

FIG. 3 is a schematic sectional view of an optical sensing apparatus, in accordance with another embodiment of the invention;

FIGS. 4A and 4B are schematic sectional views of two optical apparatuses, in accordance with further embodiments of the invention;

FIG. 4C is a schematic cross-sectional view of the apparatus of FIG. 4B; and

FIG. 5 is a schematic sectional view of an optical sensing apparatus, in accordance with yet another embodiment of the invention.

### DETAILED DESCRIPTION OF EMBODIMENTS

Some FMCW LiDAR sensing apparatuses build a depth map of a target by emitting frequency-modulated (FM) coherent optical radiation toward the target. The optical radiation reflected from the target is imaged onto an array of detectors, where it is mixed with a local beam. The beat frequencies output by the detectors are analyzed to determine the range and the velocity of the target.

For generating beat signals with a high signal-to-noise ratio (SNR), yielding an accurate depth map, it is important that the optics of the apparatus project and collect the optical radiation efficiently, with accurate focusing of the reflected radiation and high overlap with the local beam onto the detectors, because the signal (the amplitude of the beat frequency) arises from the coherent overlap (in location and phase) between the reflected radiation and the local beam. Any light that does not contribute to the overlap of the reflected radiation and the local beam may increase the noise of the measurement, even saturating the respective detectors in the array, and thus lower the quality of the depth map. Furthermore, for the reflected radiation and the local beam to mix (overlap) efficiently, they should impinge on each detector in a collinear fashion in order to increase the phase overlap and to avoid fringes in the overlapped optical fields.

Specifically, the optical path of the local beam is advantageously such that 1) the local beam fills the aperture of the objective optic imaging the target (or, in case the aperture is outside the diffracted local beam trajectory, the extrapolated local beam fills the aperture); 2) the local beam impinges onto a given detector at the same angle (i.e., chief ray angle) as the reflected radiation; and 3) stray light from the local beam is minimized. At the same time, in many applications, such as in mobile devices, space is at a premium, and the optical component count and total track length should be held to a minimum.

Embodiments of the present invention that are described herein provide an FMCW LiDAR sensing apparatus with an optical architecture based on a transparent slab comprising DOEs, which comprise diffractive structures and perform multiple functions. In various embodiments, these diffractive structures comprise, for example, surface relief gratings (SRGs), metasurfaces, or VPHS, which deflect the local beam to propagate through the slab and further deflect and project it onto the detector array. Additional diffractive structures and/or other optical elements project optical radiation onto the target and receive and focus radiation reflected from the target. The slab thus combines several optical functions into a small number of compact components, simplifying the design and fabrication of the apparatus and reducing its size.

In the disclosed embodiments, an optical sensing apparatus comprises a transmitter and a receiver on a substrate. The transmitter emits FM coherent optical radiation along a transmit axis toward a target. The receiver comprises an array of detectors of optical radiation. An objective optic (as a part of the optical train of the receiver) focuses the optical radiation that is reflected from the target onto the receiver along a receive axis.

A transparent slab is disposed over both the transmitter and the receiver. A first DOE, comprising a first diffractive structure on the first face of the slab, facing the substrate, intercepts the transmit axis and deflects a part of the FM coherent optical radiation to form a local beam propagating diagonally within the transparent slab. This local beam reflects from the second face of the slab toward a second DOE comprising a second diffractive structure, which intercepts the receive axis. The second DOE deflects and projects the reflected local beam onto the array of detectors, whereby the local beam mixes at the array with the optical radiation reflected from the target.

A number of variants on this basic system architecture are described hereinbelow. For example, in some embodiments, the first and/or the second DOEs may be located on the second face of the slab. In some embodiments, the slab may be divided into two adjacent parallel slabs. In alternative embodiments, the slab or the two adjacent slabs may comprise non-parallel plates or prisms, which may be advantageous in shortening the working distance. In some embodiments, the first and/or second

DOEs may have optical power for either focusing or collimating impinging beams. In further embodiments, a diffuser may be added to the slab or to one of the DOEs for increasing the numerical aperture of the local beam. Further embodiments are described below.

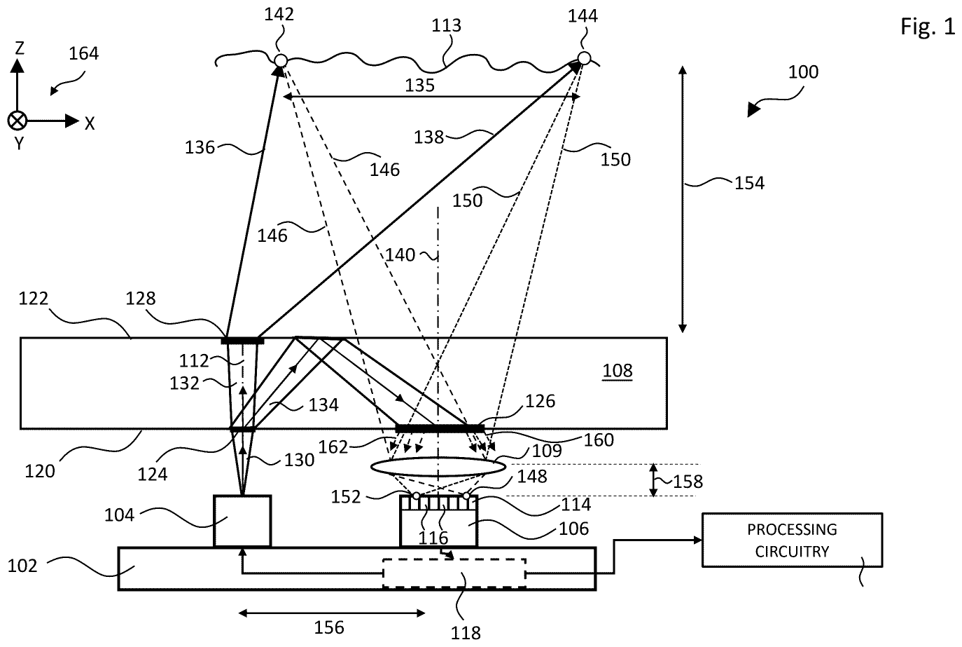

FIG. 1 is a schematic sectional view of an optical sensing apparatus 100, in accordance with an embodiment of the invention. Apparatus 100 comprises a substrate 102, such as a silicon chip, on which are disposed a transmitter 104 and a receiver 106. Apparatus 100 further comprises a transparent, plane-parallel slab 108, an objective optic 109, and processing circuitry 110.

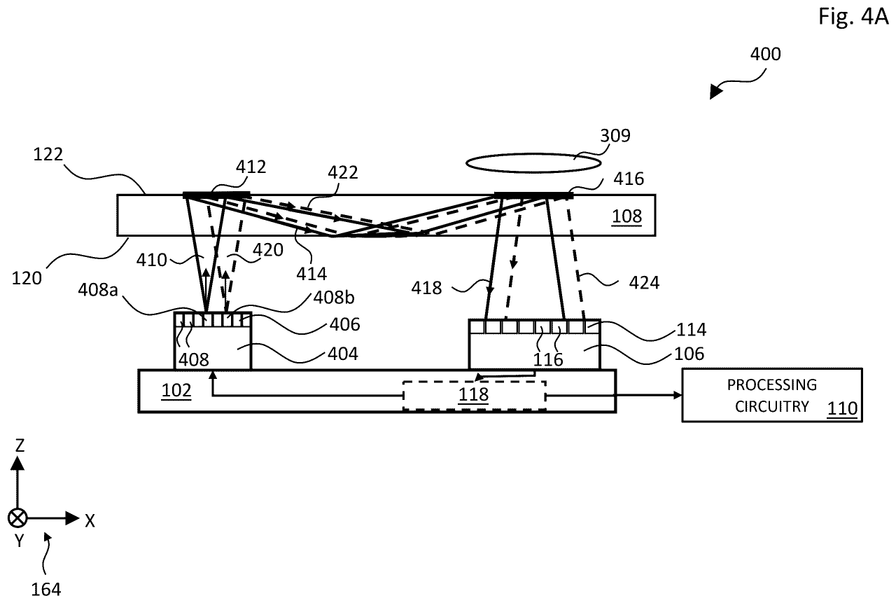

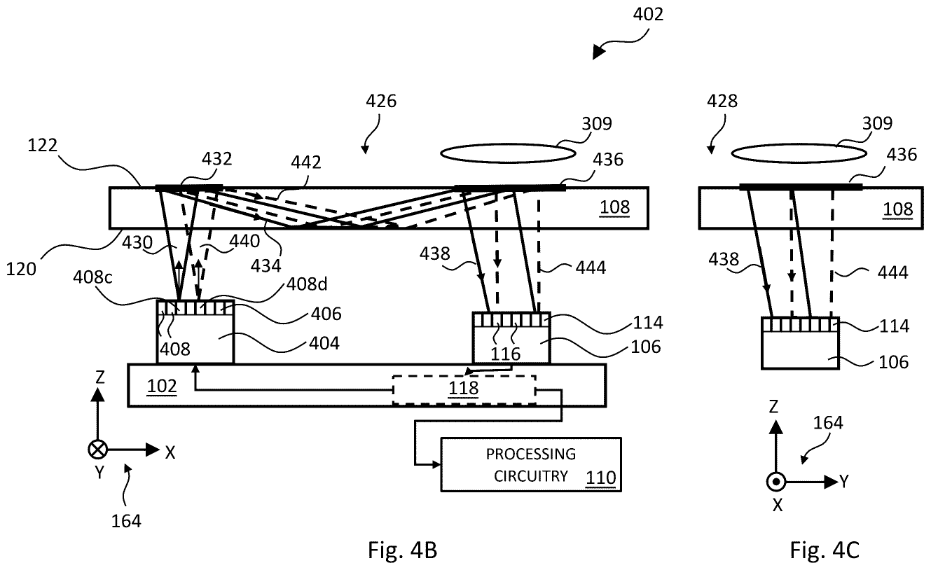

Transmitter 104 comprises a single-mode continuous-wave coherent emitter, such as a vertical-cavity surface-emitting laser (VCSEL) or vertical-external-cavity surface-emitting laser (VeCSEL) or photonic cavity surface emitting laser (PCSEL). Transmitter 104 emits optical radiation along a transmit axis 112 toward a target 113. The radiation is emitted typically at a near-infrared wavelength (NIR, for example 940 nm) or at a short-wavelength infrared wavelength (SWIR, for example 1300 nm). Transmitter 104 is typically fabricated from a III-V (direct bandgap) material and bonded to substrate 102. Alternatively, other types of emitters of coherent optical radiation may be used, possibly with other emission wavelengths. Further alternatively, an array of emitters, such as an array of VCSELs, may be used, as will be further detailed in FIGS. 4A and 4B hereinbelow.

Receiver 106 comprises an array 114 of detectors 116 of optical radiation. The detectors may advantageously comprise single-photon avalanche-photodiodes (SPADs), for example as described in U.S. patent application Ser. No. 18/623,080, filed Apr. 1, 2024, whose disclosure is incorporated herein by reference. Alternatively, other types o 4 detectors may be used, such as balanced pairs of photodiodes. Detectors 116 are made from, for example, doped silicon or silicon-germanium (SiGe).

Driving and amplification circuitry 118 on substrate 102 is coupled to transmitter 104, receiver 106, and processing circuitry 110, and provides drive signals to the transmitter and amplification processing for the receiver output. Driving and amplification circuitry 118 may alternatively be external to substrate 102. Further alternatively, processing circuitry 110 may be integrated on substrate 102 with driving and amplification circuitry 118. Processing circuitry 110 receives electrical signals output from detectors 116 via driving and amplification circuitry 118 and extracts a beat frequency from the electrical signals. Processing circuitry 110 and driving and amplification circuitry 118 comprise analog and/or digital electronic components for carrying out the functions that are described herein.

Slab 108 is made of glass, plastic, or other material transparent at the wavelength of optical radiation emitted by transmitter 104. Slab 108 is disposed over both transmitter 104 and receiver 106 and has a first face 120 facing substrate 102 and a second face 122 opposite the first face. Slab 108 in this embodiment comprises a first DOE 124 and a second DOE 126 on first face 120, and a beam conditioner 128 (as explained below) on second face 122. The structures and the functions of DOEs 124 and 126 and beam conditioner 128 are described hereinbelow together with the description of the functionality of apparatus 100.

As shown in FIG. 1, objective optic 109 is separated from first face 120 of slab 108. Alternatively, objective optic 109 may be cemented to first face 120 with low-index optically clear adhesive (OCA). Further alternatively, objective optic 109 may comprise a DOE (such as a metasurface or other diffractive structure) and be integrated with DOE 126. The optical power of objective optic 109 is chosen to accommodate a certain target field of view 135.

For mapping target 113, transmitter 104 emits coherent continuous-wave optical radiation into a conical beam 130 along transmit axis 112, while the frequency of the radiation is modulated by circuitry 118. Beam 130 impinges on first DOE 124, which comprises a one-dimensional diffraction grating, such as an SRG. (Alternatively, first DOE 124 may comprise a beamsplitting metasurface or a hologram, such as a VPH, with added optical power, for example to collimate beam 132 and/or 134.) The grating splits beam 130 into a transmitted beam 132 (0^{th} diffracted order of the grating), which is transmitted toward target 113, and into a local beam 134 (a single first-order or higher diffracted order of the grating). Between 1% and 5% of the optical power in beam 130 is typically split into local beam 134. The angle into which first DOE 124 deflects local beam 134 is selected so that, taking into account the refractive index of slab 108, the local beam propagates in the slab by total internal reflection (TIR), reflecting from face 122 and impinging on second DOE 126. Thus, slab 108 acts as a waveguide, guiding local beam 134.

Alternatively, especially for a thin slab 108, local beam 134 may propagate by repeated internal reflections from both second face 122 and first face 120. A reflective coating may be added in selected locations on faces 120, 122 of slab 108 for ensuring reflections within the slab.

Beam 132 is transmitted through slab 108 onto beam conditioner 128. Beam conditioner 128 may comprise, for example, a grating, a metasurface, a hologram, or a diffuser. Beam conditioner 128 processes beam 132 either to project discrete, collimated beams toward target 113, illuminating the target with a pattern of spots, or to project a single broad beam that illuminates the target with uniform or quasi-uniform flood illumination. The extent of illumination over a field-of-view (FOV) 135 on target 113 (either spot patterns or flood illumination) is shown schematically by arrows 136 and 138.

When illuminating target 113, some of the optical radiation reflected from target 113 is directed into apparatus 100 along a receive axis 140, as shown using two extreme target points 142 and 144 as examples. Optical radiation reflected from point 142 on target 113 is denoted by rays 146, which pass through slab 108 and second DOE 126 and are collected and projected by objective optic 109 to a point 148 on detector array 114. Similarly, optical radiation reflected from point 144 is denoted by rays 150, which pass through slab 108 and second DOE 126 and are collected and projected by objective optic 109 to a point 152 on detector array 114.

Local beam 134 is deflected and projected by DOE 126 toward objective optic 109 and detector array 114. DOE 126, comprising a diffractive structure (SRG, VPH, or metasurface, for example), possibly with optical power. DOE 126 deflects local beam 134 toward array 114. For example, arrows 160 denote a portion of local beam 134 deflected and collimated toward point 148 and mixing there with rays 146 reflected from point 142 on target 113, and arrows 162 denote another portion of the local beam deflected and collimated toward point 152 and mixing there with rays 150 from point 144 on the target. Similarly, optical radiation reflected from each point on target 113 within FOV 135 toward apparatus 100 mixes with a portion of local beam 134 deflected by DOE 126.

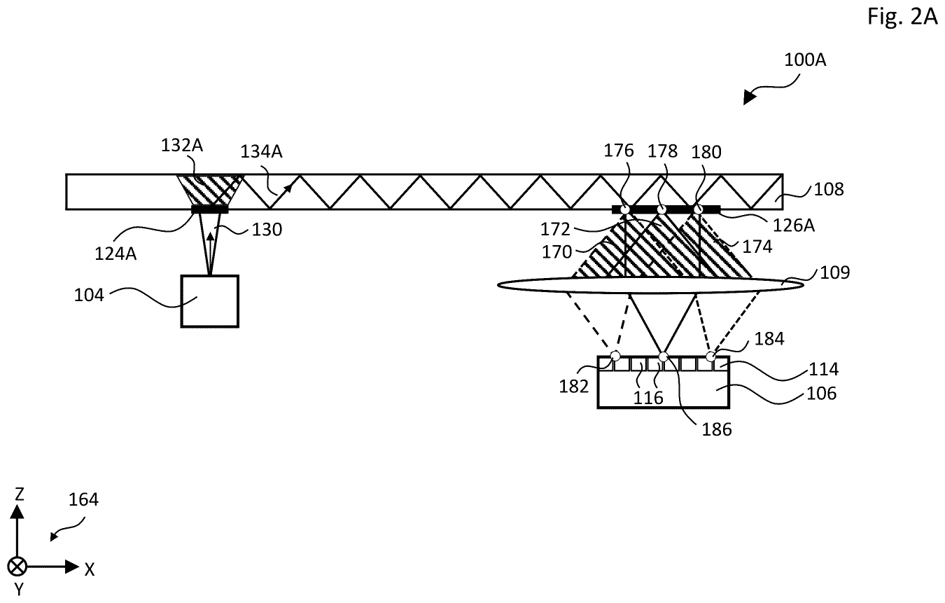

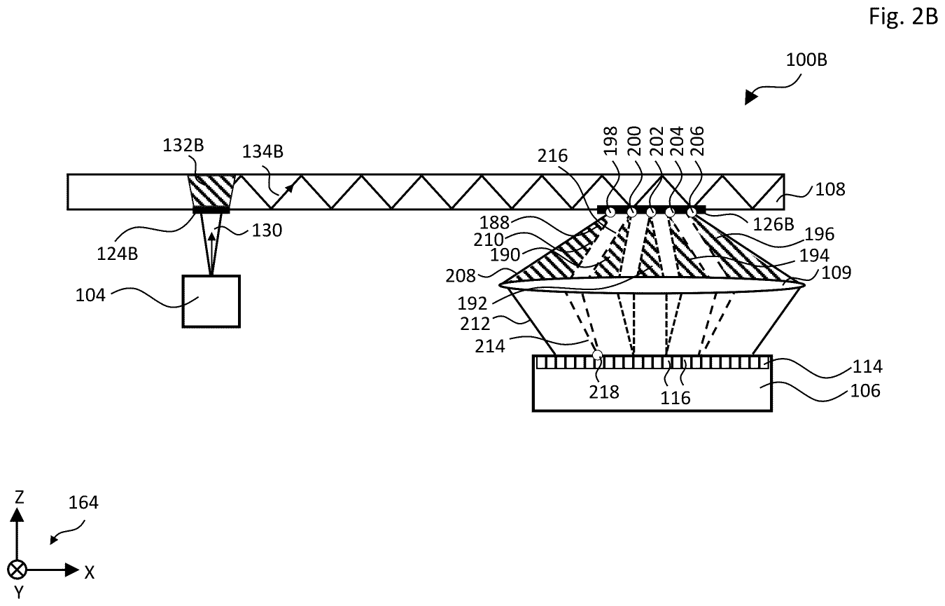

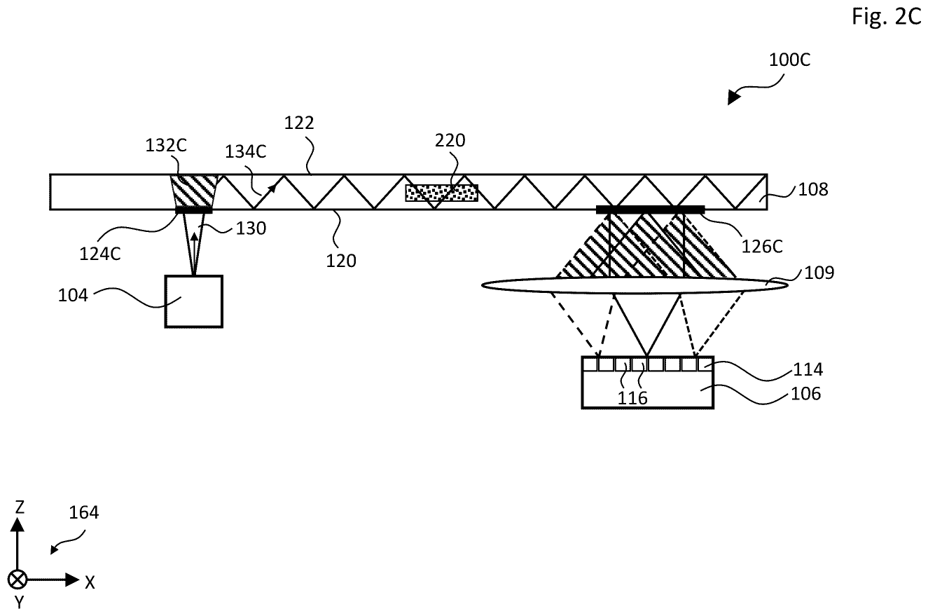

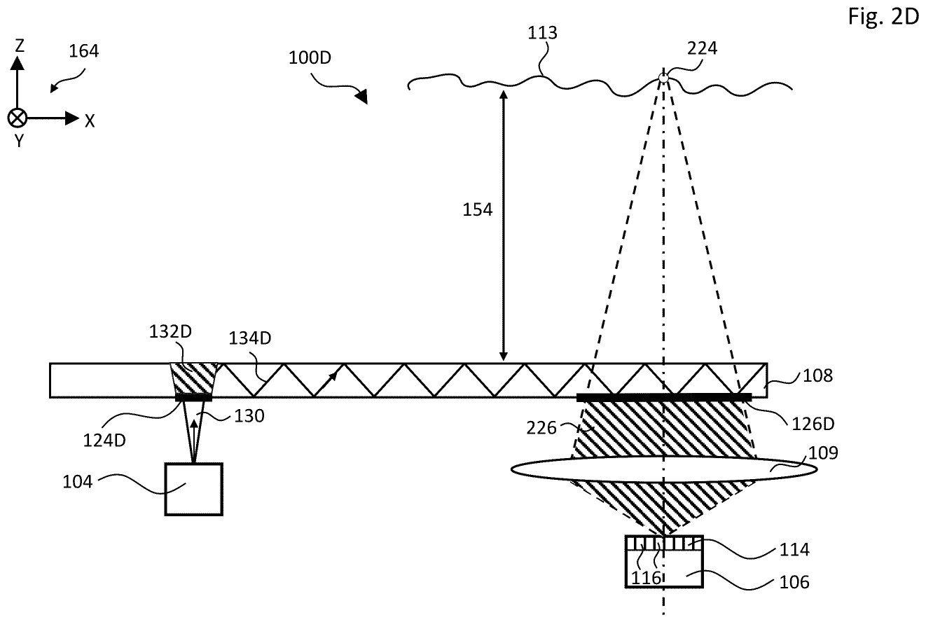

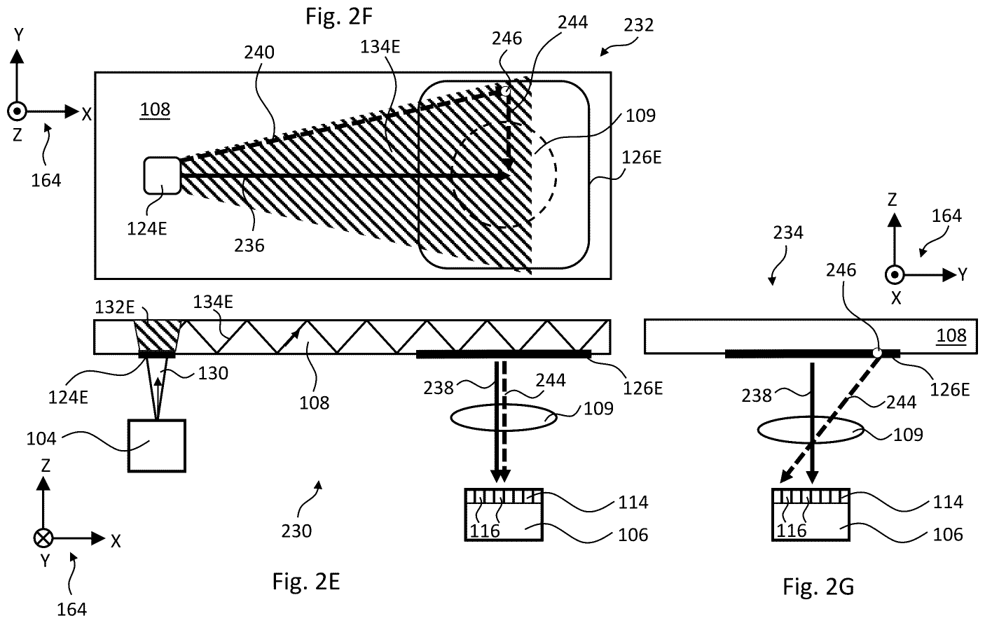

With reference to Cartesian coordinates 164, arrows 160 and 162 show diffraction only in the XZ-plane. However, especially for a large distance between first face 120 and objective optic 109, it is advantageous to have second DOE 126 diffract portions of local beam 134 also in the Y-direction toward the objective optic. This may be accomplished using, as further shown in FIGS. 2E-2G hereinbelow, a diffractive structure for second DOE 126, whose diffractive properties vary spatially in the Y-direction.

FIGS. 2A-2D are schematic sectional detail views 100A, 100B, 100C, and 100D, respectively, showing alternative schemes of propagation of the local beam in apparatus 100, in accordance with embodiments of the invention. Components of views 100A, 100B, 100C, and 100D that are similar or identical to components of apparatus 100 are labeled with the same reference numbers, and their descriptions are omitted here for the sake of brevity. Further for the sake of brevity and clarity, components and descriptions that are not relevant to the propagation of the local beam (such as those relating to target illumination, substrate 102, and electronic items) are omitted.

Referring to FIG. 2A, transmitter 104 emits (as previously described in reference to FIG. 1) coherent continuous-wave FM optical radiation into conical beam 130. Beam 130 impinges on a first DOE 124A, which can increase the numerical aperture (NA) of the beam as it splits and deflects a local beam 134A out of it through transmission. (Having DOE 124A on the opposite face of slab 108 would cause local beam 134A to split and be deflected through reflection.) DOE 124A comprises one or more of the following alternative components: 1) a VPH with optical power, 2) a metasurface with optical power, 3) an SRG with optical power, 4) a combination of an SRG and a diffuser, or 5) a combination of an SRG and a refractive optical lens. The change (in this case increase) of the NA is shown schematically for a non-deflected beam 132A after DOE 124A; for the sake of clarity, local beam 134A is shown as a single line (corresponding to the chief ray), although it propagates within slab 108 with the same (or similar) NA as beam 132A. The increase of the NA by DOE 124A is limited by the ability of beam conditioner 128 (FIG. 1) to effectively collimate the beam (when required) and by the requirement that local beam 134A propagate within slab 108 by TIR. Thus, for example, for a slab 108 with a refractive index n=2 and local beam 134A with a ±10 degree cone angle, the angles of propagation in the XZ-plane are limited to between ±50 degrees with respect to the X-axis.

Local beam 134A propagates within slab 108 to a second DOE 126A. For a sufficiently thin slab 108, local beam 134A impinges on second DOE 126A multiple times, thus replicating itself on the second DOE. (This sort of process is known as “pupil replication.”) Second DOE 126A, comprising an SRG, deflects and projects, through diffraction, local beam 134A out of slab 108, as shown schematically by cones 170, 172, and 174, which are coupled out from respective points 176, 178, and 180 on the second DOE, and further refracted and projected by objective optic 109 onto detector array 114. Each cone 170, 172, and 174 has the same NA as local beam 134A, and, due to the pupil replication described above, fill the aperture of objective optic 109. This kind of pupil replication is advantageous in case of a narrow local beam 134A which, even with the increased NA, still does not fill objective optic 109 after diffraction from second DOE 126A. The area on detector array 114 that is illuminated by the optical radiation coupled out of local beam 134A extends from a point 182 to a point 184. A point 186 is illuminated by rays that are diffracted by second DOE 126 in the negative Z-direction. Both the area illuminated by local beam 134A and the angles of the illuminating rays are matched to those of the rays of optical radiation reflected from the target (not shown in the figure).

In the embodiment of FIG. 2B, the emitted conical beam 130 impinges on a first DOE 124B, which splits out and deflects a local beam 134B (without increasing its NA). Local beam 134B propagates within slab 108 to a second DOE 126B. Similarly to local beam 134A (FIG. 2A), local beam 134B impinges on second DOE 126B multiple times for pupil replication. Second DOE 126B comprises a diffractive structure (SRG, VPH, or metasurface, for example) with optical power and deflects and projects local beam 134B out of slab 108 and onto objective optic 109, as shown schematically by cones 188, 190, 192, 194, and 196, which are coupled out from respective points 198, 200, 202, 204, and 206 on the second DOE. Each cone 188, 190, 192, 194, and 196 has an NA somewhat exceeding that of local beam 134B, and the tilt angles of the cones chief rays change gradually, due to the optical power of second DOE 126B, as the point of out-coupling moves across the second DOE. Second DOE 126B and detector array 114 are located respectively in the front and rear focal planes of objective optic 109, and the optical radiation in each of cones 188, 190, 192, 194, and 196 is projected by the objective optic onto detector array as a collimated beam. Thus, for example, marginal rays 208 and 210 of cone 188 are projected onto detector array 114 as respective parallel rays 212 and 214. On the other hand, parallel rays diffracted by DOE 126B focus to a point on detector array 114. Thus, for example, marginal ray 210 of cone 188 and a marginal ray 216 of cone 190, parallel to ray 210, focus to a point 218. Moreover, each cone diffracted out of a point between points 198 and 200 comprises a ray that is parallel to marginal rays 210 and 216, and thus focuses to point 218. These features apply to all points on second DOE 126B.

In an alternative embodiment, the SRG of first DOE 124B may have some optical power, thus moderately increasing the NA of local beam 134B. Thus, the optical powers of first DOE 124B and second DOE 126B both contribute to the area of detector array 114 that is illuminated by local beam 134B.

As will be further detailed in FIG. 2D hereinbelow, the optical power of second DOE 126B may be selected to match the angles of the diffracted local beam to distance 154 to target 113.

In the embodiment of FIG. 2C, conical beam 130 impinges on a first DOE 124C, which is similar to first DOE 124B in FIG. 2B, comprising an SRG and splitting out and deflecting a local beam 134C, while conserving the NA of cone 130. A second DOE 126C is similar to second DOE 126A in FIG. 2A, comprising an SRG. However, the NA of local beam 134C, initially that of cone 130, is increased by a diffuser 220, such as a volume diffuser, embedded in slab 108 between first DOE 124C and second DOE 126C. In an alternative embodiment, a discrete diffuser (not shown) may be cemented to first face 120 or second face 122 of slab 108 using OCA. Such a surface diffuser may comprise, for example, an element with a rough surface or a DOE that is configured to diffuse impinging optical radiation. The discrete diffuser may also be cemented to second DOE 126C. Further alternatively, one or both of faces 120, 122 of slab 108 may comprise a diffusing area, such as a diffusely etched or roughened surface area. Although specific forms and fabrication methods of diffusers have been described hereinabove, all suitable forms and fabrication methods of diffusers that increase the beam divergence can be used and are considered to be within the scope of the invention.

In the embodiment of FIG. 2D, conical beam 130 impinges on a first DOE 124D, which comprises an SRG similar to first DOE 124B in FIG. 2B, and splits out and deflects a local beam 134D while conserving the NA of cone 130. A second DOE 126D comprises a diffractive structure with optical power. This optical power is selected so that the distance of an extrapolated rear focal point 224 of a diffracted local beam 226 from slab 108 equals the distance 154 of target 113 from slab 108, which enhances the overlap of the diffracted local beam with optical radiation reflected from the target. The selection of the optical power of DOE 126D may be relevant when distance 154 is relatively short and well defined. However, long distances 154 may be considered infinite for the optical design, and DOE 126D may then have zero optical power. When using a VPH as second DOE 126D, the VPH may be fabricated so that diffracted local beam 226 comprises plane waves, and is thus optimized for an infinite virtual image distance. In general, DOE 126D may be fabricated to have an optical power suitable to the intended distance 154 used for the apparatus.

In an alternative embodiment, specifically advantageous for a local beam 134D with a small cross-section, second DOE 126D comprises a diffuser VPH, i.e., a VPH having both focusing and diffusing properties. The optical power is selected to match the target distance, as described hereinabove, and the diffusing properties are selected so as to expand local beam 134D to have a broad angular content after diffraction and thus, after refraction by objective optic 109, cover a large contiguous area on detector array 114. A diffuser VPH may be written using a sum of an optical wave with a virtual focal distance (either finite or infinite) and a diffuse optical wave as one of the interfering waves.

In a further alternative embodiment, second DOE 126D {The interlacing might be relevant for any 126, not just 126D} comprises interleaved areas alternatingly focusing the deflected local beam onto detector array 114 and transmitting and focusing optical radiation reflected from the target onto the detector array. An MOE with this sort of interleaved design is described, for example, in U.S. Provisional Patent Application 63/665,868, filed Jun. 28, 2024, whose disclosure is incorporated herein by reference. Furthermore, interleaving or multiplexing of this sort may be applied to DOEs 126, 126A, 126B, 126C, and 2E in respective FIGS. 1, 2A, 2B, 2C, and 2E-2G.

FIGS. 2E, 2F and 2G show respective schematic views 230, 232, and 234, illustrating a further alternative scheme of propagation of the local beam in apparatus 100, in accordance with an embodiment of the invention. With reference to Cartesian coordinates 164, view 230 is a sectional view in the ZX-plane, view 232 is a top-down view in the XY-plane, and view 234 is a sectional view in the YZ-plane (across receiver 106).

Components of schematic views 230, 232, and 234 that are similar or identical to components of apparatus 100 are labeled with the same reference numbers, and their description is omitted here for the sake of brevity. Similarly to FIGS. 2A-2D, components and descriptions that are not relevant for the propagation of the local beam are omitted.

Conical beam 130 impinges on a first DOE 124E, which comprises a VPH that splits out and deflects a local beam 134E while increasing the NA of the local beam in the XY-plane, as shown in view 232. (In an alternative embodiment, first DOE 124E may comprise an SRG with suitable optical power.) Local beam 134E propagates in slab 108 to second DOE 126E, which comprises a VPH whose diffractive properties vary in the Y-direction, adding a negative Y-component to its grating vector at positive Y-coordinates and a positive Y-component at negative Y-coordinates. A ray 236 of local beam 134E, which propagates in the XY-plane along the X-axis and is shown as a solid arrow, diffracts from DOE 126E to the ZX-plane, and is shown by a diffracted ray 238 in views 230 and 234. However, an oblique ray 240 of local beam 134E, propagating in XY-plane but not along the X-axis, shown as a dotted arrow, diffracts from DOE 126E obliquely in the YZ plane to an oblique diffracted ray 244. Due to this oblique diffraction, ray 244 is projected toward objective optic 109, although a point 246 from which it was diffracted is not located above the objective optic.

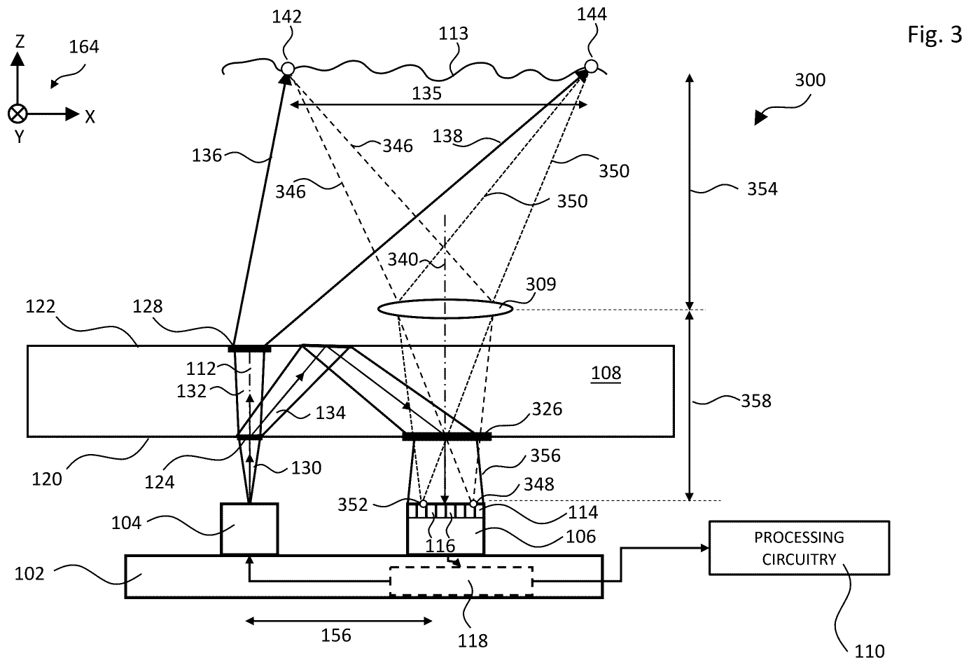

FIG. 3 is a schematic sectional view of an optical sensing apparatus 300, in accordance with another embodiment of the invention. Apparatus 300 is similar to apparatus 100, with the following difference: Whereas apparatus 100 comprises objective optic 109 below slab 108 (between the slab and substrate 102), apparatus 300 comprises an objective optic 309 above slab 108 (i.e., the slab is located between the objective optic and the substrate). Additional changes in the components of apparatus 300 are detailed hereinbelow. Components of apparatus 300 that are similar or identical to components of apparatus 100 (such as above-mentioned slab 108 and substrate 102) are labeled with the same reference numbers, and their description is omitted here for the sake of brevity.

The functioning of apparatus 300 for mapping target 113 is described hereinbelow using illumination identical to that of apparatus 100 in FIG. 1, and following optical radiation reflected from target points 142 and 144. Some of the reflected radiation is directed into apparatus 300 along a receive axis 340. Optical radiation reflected from point 142 on target 113 is denoted by rays 346, which are collected and projected by objective optic 309 through slab 108 and a second DOE 326 to a point 348 on detector array 114. Similarly, optical radiation reflected from point 144 is denoted by rays 350 and is collected and projected by objective optic 309 through slab 108 and second DOE 326 to a point 352 on detector array 114.

Local beam 134 is diffracted by second DOE 326, comprising an SRG, toward detector array 114 as a beam 356, where it mixes with the optical radiation reflected from target 113.

As shown in FIG. 3, objective optic 309 is separated from slab 108. In an alternative embodiment, objective optic 309 may be cemented to second face 122 of slab 108 with low-index optically clear adhesive (OCA). Further alternatively, objective optic 309 may comprise a DOE (such as metasurface or a VPH) on second face 122.

FIGS. 4A and 4B are schematic sectional views of optical apparatuses 400 and 402, respectively, in accordance with further embodiments of the invention, while FIG. 4C is a schematic cross-sectional view of apparatus 402. Optical apparatuses 400 and 402 are similar to apparatus 300, having objective optic 309 above slab 108. However, instead of transmitter 104 with a single source of radiation, each of apparatuses 400 and 402 comprises a transmitter 404 comprising a two-dimensional array 406 of VCSELs 408. VCSELs 408 may be activated either separately or in a combination of multiple VCSELs. Furthermore, apparatuses 400 and 402 differ from apparatus 300 in that the DOEs directing the local beam, as further detailed hereinbelow, are located on second face 122 of slab 108. Components of apparatuses 400 and 402 that are similar or identical to components of apparatus 300 are labeled with the same reference numbers, and their description is omitted here for the sake of brevity. The objective of FIGS. 4A and 4B is to show the propagation of respective local beams in apparatuses 400 and 402, and therefore the description of the optical radiation projected to the target and reflected back to the respective apparatuses is omitted for the sake of brevity.

With reference to FIG. 4A, when a VCSEL 408a in array 406 is activated, it emits optical radiation into a cone 410, which propagates through slab 108 and impinges on a first DOE 412 on second face 122 of the slab. First DOE 412 comprises a diffractive structure such as an SRG or VPH, which splits and deflects a local beam 414, shown as solid lines, from the optical radiation in cone 410. (Additional functions of first DOE 412, as well as other optical components required for projecting optical radiation to a target, have been omitted.) Local beam 414 propagates in slab 108 by TIR and impinges on a second DOE 416 on second face 122. Second DOE 416 comprises a diffractive structure such as an SRG or VPH, and it deflects local beam 414 into a diffracted local beam 418 and projects it onto detector array 114. Another VCSEL 408b emits optical radiation into a cone 420, which is split and deflected into a local beam 422 (shown as dotted lines) by first DOE 412, and further deflected by second DOE 416 into a diffracted local beam 424 and projected onto array 114. The two diffracted local beams 418 and 424 impinge on array 114 with the same NA and the same directionality, but are shifted laterally with respect to each other. Thus, the local beams projected onto array 114 is scanned laterally according to the activated VCSELs 408 in array 406. The area of detector array 114 that is illuminated by the local beam is highly correlated to the location of the image of the spot on the target from the same activated VCSEL 408.

The angular and/or lateral extent of each local beam, such as local beams 418 and 424, may be reduced by reducing the NA of each cone of optical radiation emitted by the respective VCSEL or by adding optical power to first DOE 412. This reduces the area illuminated by the respective local beam on array 114.

FIGS. 4B and 4C show sectional views 426 and 428 of apparatus 402 along ZX- and YZ-planes respectively, with sectional view 428 located at receiver 106. When a VCSEL 408c in array 406 is activated, it emits optical radiation into a cone 430, which propagates through slab 108 and impinges on a first DOE 432 on second face 122 of the slab. First DOE 432 comprises a diffractive structure, which (similarly to first DOE 412 in FIG. 4A) splits and deflects a local beam 434, shown as solid lines, from the optical radiation in cone 430. Local beam 434 propagates in slab 108 by TIR and impinges on a second DOE 436 on second face 122. Second DOE 436 comprises an SRG or a VPH with optical power, deflecting and focusing local beam 434 and projecting it as a collimated local beam 438 through slab 108 onto detector array 114. VCSEL 408c is offset on array 406 in both the X-and Y-directions so that collimated local beam 438 impinges on array 114 at oblique angles in both sectional views 426 and 428.

Another VCSEL 408d emits optical radiation into a cone 440, which is split and deflected into a local beam 442 (shown as dotted lines) by first DOE 432, and further deflected by second DOE 436 into a collimated local beam 444 and projected onto array 114. VCSEL 408d is located at a symmetrical location on array 406, and therefore collimated local beam 444 impinges perpendicularly on array 114. The two collimated local beams 438 and 444 impinge on array 114 at different angles and may also be shifted laterally with respect to each other. Thus, the local beams projected onto array 114 may be scanned both angularly and laterally by selectively activating an appropriate VCSEL 408 in array 406.

In an alternative embodiment, first DOE 432 (instead of second DOE 436) may have optical power, collimating the local beams propagating in slab 108, such as beams 434 and 440. The local beams will impinge on detector array 114 at different angles (and possibly with lateral shifts) similarly to beams 438 and 444.

The degrees of freedom of the local beam, such as beam size, location and angle on detector array 114, may be exploited to maximize the overlap with the corresponding light reflected from the target by matching the angles of the respective chief rays and by setting the local beam size to account for misalignment tolerances.

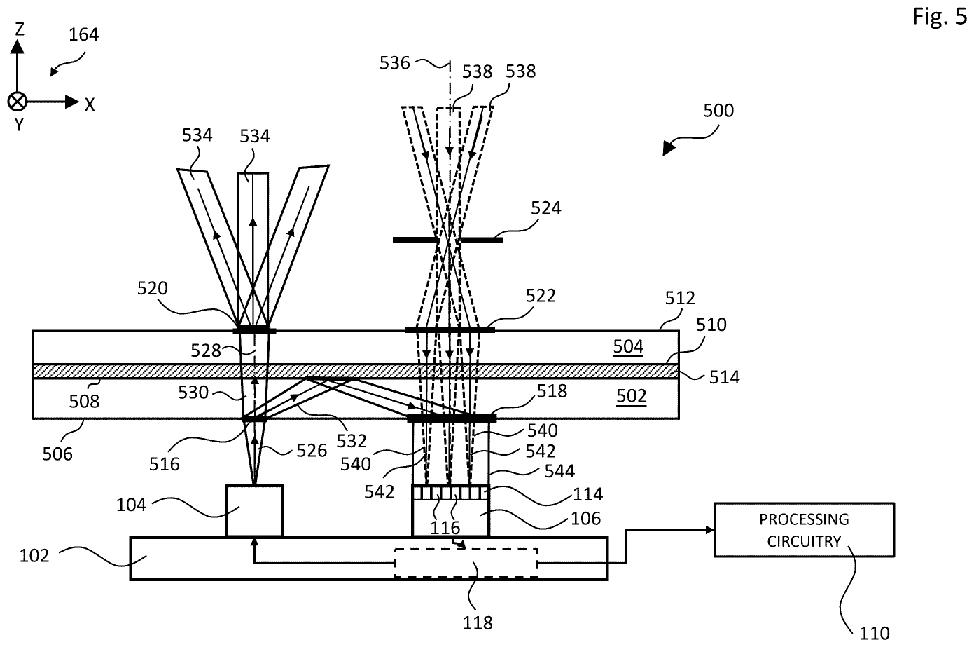

FIG. 5 is a schematic sectional view of an optical sensing apparatus 500, in accordance with yet another embodiment of the invention. Components of apparatus 500 that are similar or identical to components of apparatus 100 are labeled with the same reference numbers, and their description is omitted here for the sake of brevity.

Apparatus 500 comprises a first slab 502 and a second slab 504, each comprising a transparent, plane-parallel slab made of glass, plastic, or other material transparent at the wavelength of radiation emitted by transmitter 104. First slab 502 comprises a lower first face 506, facing substrate 102, and an upper first face 508. Second slab 504, parallel to first slab 502, comprises a lower second face 510, facing upper first face 508 of first slab 502, and an upper second face 512. Slabs 502 and 504 are cemented to each other with OCA 514 having a refractive index lower than that of slab 502. In this sense, slabs 502 and 504 may together be regarded as a single compound slab.

Slab 502 comprises a first DOE 516 and a second DOE 518. Slab 504 comprises a third DOE 520 and a fourth DOE 522. Additionally, apparatus 500 comprises an optical aperture 524. The structures and the functions of DOEs 516, 518, 520 and 522 are described together with the description of the functionality of apparatus 500 hereinbelow.

Transmitter 104 in apparatus 500 emits coherent continuous-wave FM optical radiation into a conical beam 526 along a transmit axis 528. Beam 526 impinges on first DOE 516, which comprises a diffraction grating, splitting beam 526 into a transmitted beam 530 (0^{th} diffracted order of the grating) and into a local beam 532 (a single first or higher diffracted order). Local beam 532 propagates in lower slab 502 by TIR, reflecting from face 508 and impinging on second DOE 518.

As has been previously described in reference to FIGS. 2A-2C, the NA of local beam 532 propagating in slab 502 may be controlled by the design of first DOE 516, as well as by diffusers within the slab. However, the NA of local beam 532 is limited by the refractive-index difference between first slab 502 and OCA 514: The lower the refractive index of OCA 514, the higher is the upper limit of the NA. In an alternative embodiment, OCA 514 is replaced by an air gap, with suitably placed spacers (not shown), or the OCA may be applied only to the periphery of the interface, keeping the interior of slabs 502 and 504 apart, which permits a further increase in the upper limit of the NA of local beam 532.

Depending on the thickness of slab 502, its refractive index and the propagation angle of local beam 532, the local beam may reflect multiple times from faces 506 and 508. A reflective coating may be added in selected locations on faces 506, 508 of slab 502 for ensuring reflections of marginal rays of local beam 532 within the slab.

Beam 530 is transmitted through slabs 502 and 504 and OCA 514 onto third DOE 520, which collimates the impinging beam by adding a collimating phase and splits the beam into a two-dimensional array of collimated beams 534, which illuminate a target (not shown) with a pattern of spots. Some of the optical radiation reflected from the target returns to apparatus 500 along a receive axis 536 as beams 538, passing through optical aperture 524 functioning as an optical stop, to fourth DOE 522. Fourth DOE 522 comprises one or more metasurfaces, which focus beams 538 to focused beams 540 and projects them through slabs 504 and 502 and second DOE 518 onto detector array 114. If aperture 524 is placed at a focal length away from DOE 522, then chief rays 542 of focused beams 540 impinge perpendicularly on array 114.

Second DOE 518, comprising a VPH (or alternatively a metasurface), deflects and collimates local beam 532 into a collimated beam 544, which impinges perpendicularly on detector array 144, covering the array. As beams 540 and 544 overlap and have parallel directions, they mix on array 144.

Alternatively, second DOE 518 may deflect and divide local beam 532 and focus each of the divided beams to a respective focus of each of beams 540.

Similarly to second DOE 126D, second DOE 518 may in an alternative embodiment comprise interleaved diffractive structures as required to perform the functions described hereinabove.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Optical sensing apparatus, comprising:
a substrate;
a transmitter, which is disposed on the substrate and is configured to emit frequency-modulated (FM) coherent optical radiation along a transmit axis toward a target;
a receiver, which is disposed on the substrate alongside the transmitter and comprises an array of detectors of optical radiation;
an objective optic configured to focus the optical radiation that is reflected from the target onto the receiver along a receive axis; and
a transparent slab, which is disposed over the transmitter and the receiver and has a first face facing the substrate and a second face opposite the first face, and which comprises:
a first diffractive structure, which is disposed in a first location intercepting the transmit axis and is configured to deflect a part of the FM coherent optical radiation to form a local beam propagating diagonally within the transparent slab and reflecting from the second face toward the receive axis; and
a second diffractive structure, which is disposed in a second location intercepting the receive axis and is configured to deflect and project the reflected local beam onto the array of detectors, whereby the local beam mixes at the array with the optical radiation reflected from the target.

2. The apparatus according to claim 1, wherein at least one of the first and second diffractive structures comprises a diffraction grating.

3. The apparatus according to claim 2, wherein the diffraction grating comprises a surface relief grating (SRG).

4. The apparatus according to claim 1, wherein at least one of the first and second diffractive structures comprises a metasurface.

5. The apparatus according to claim 1, wherein at least one of the first and second diffractive structures comprises a hologram.

6. The apparatus according to claim 5, wherein the hologram comprises a volume phase hologram (VPH).

7. The apparatus according to claim 1, wherein the first diffractive structure is configured to focus optical radiation impinging on the diffractive structure.

8. The apparatus according to claim 1, and comprising a refractive optical lens adjacent to the first diffractive structure.

9. The apparatus according to claim 1, and comprising an optical diffuser adjacent to the first diffractive structure.

10. The apparatus according to claim 1, wherein the second diffractive structure is configured to focus optical radiation impinging on the second diffractive structure.

11. The apparatus according to claim 1, and comprising an optical diffuser adjacent to the second diffractive structure.

12. The apparatus according to claim 1, wherein the second diffractive structure comprises first diffractive elements configured to deflect and focus the local beam onto the detector array interleaved with second diffractive elements configured to transmit and focus the optical radiation reflected from the target onto the detector array.

13. The apparatus according to claim 1, wherein the transparent slab comprises an optical diffuser configured to diffuse the local beam.

14. The apparatus according to claim 1, and comprising a beam conditioner disposed on the second face of the transparent slab and configured to receive the optical radiation transmitted by the first diffractive structure and to project the optical radiation onto the target.

15. The apparatus according to claim 14, wherein the beam conditioner is selected from a group of optical elements consisting of a diffractive structure, a diffuser, and a refractive optical element.

16. The apparatus according to claim 14, wherein the transparent slab comprises a compound slab, which comprises a first slab comprising the first and second diffractive structures and a second slab, parallel to the first slab, comprising the beam conditioner.

17. The apparatus according to claim 16, wherein the objective optic comprises a diffractive structure disposed on the second slab.

18. The apparatus according to claim 1, wherein the objective optic comprises a diffractive structure disposed on one of the faces of the slab.

19. The apparatus according to claim 1, wherein the second diffractive structure has diffractive properties that vary along a direction that is perpendicular to a line connecting the first diffractive structure to the second diffractive structure.

20. A method for optical sensing, comprising:
emitting frequency-modulated (FM) coherent optical radiation along a transmit axis toward a target;
focusing optical radiation that is reflected from the target along a receive axis onto an array of optical detectors;
positioning a transparent slab to intercept the transmit and receive axes, the slab having a first face and a second face opposite the first face and facing toward the target, the second face comprising:
a first diffractive structure, which is disposed in a first location intercepting the transmit axis and is configured to deflect a part of the FM coherent optical radiation to form a local beam propagating diagonally within the transparent slab and reflecting from the second face toward the receive axis; and
a second diffractive structure, which is disposed in a second location intercepting the receive axis and is configured to deflect and project the reflected local beam onto the array of detectors, whereby the local beam mixes at the array with the optical radiation reflected from the target.
